(19) United States
(12) Patent Application Publication
(10) Pub. No.: US 2025/0267407 A1
(43) Pub. Date: Aug. 21, 2025

(54) SPEAKER ASSEMBLY

(71) Applicant: Apple Inc., Cupertino, CA (US)

(72) Inventors: Alison B. Shutzberg, San Francisco, CA (US); Martial A. Rousseau, Saratoga, CA (US)

(21) Appl. No.: 18/856,434

(22) PCT Filed: Apr. 14, 2023
(86) PCT No.: PCT/US2023/018691

§ 371 Date: Oct. 11, 2024

Related U.S. Application Data
(60) Provisional application No. 63/363,161, filed on Apr. 18, 2022.

(51) Int. Cl. H04R 7/20; G02C 11/00; H04R 1/02; H04R 7/04; H04R 9/02

(52) U.S. Cl. CPC H04R 7/20; H04R 1/025; H04R 1/028; H04R 7/04; H04R 9/025; G02C 11/10; H04R 2499/15

(57) ABSTRACT

An electronic device, including a housing defining an opening, a speaker unit disposed within the housing and adjacent the opening, the speaker unit including an asymmetric diaphragm, and an asymmetric magnet assembly. The speaker unit can include a housing defining an internal volume, an asymmetric driver disposed in the housing; and a surround comprising a variable stiffness.

### CROSS-REFERENCE TO RELATED APPLICATION(S)

This application is a national stage filing based off of PCT Application No. PCT/US2023/018691 filed 14 Apr. 2023, and entitled “SPEAKER ASSEMBLY,” which claims priority to U.S. Provisional Patent Application No. 63/363,161, filed 18 Apr. 2022, and entitled “SPEAKER ASSEMBLY,” the entire disclosure of which is hereby incorporated by reference.

### FIELD

The described embodiments relate generally to electronic devices. More particularly, the present embodiments relate to speaker assemblies for electronic devices.

### BACKGROUND

Over the past several decades, the functionality of electronic devices drastically advanced and computer parts have been miniaturized while also increasing performance. Electronic devices typically include a housing that surrounds internal system components, such as audio speaker assemblies, circuitry, processing units, display elements, and other electronic components. Reducing the size of these various components can offer more efficient use of space, greater flexibility in the placement of the components within the housing, reduced housing size and use of material, smaller device sizes, greater ease of transportation and use, and other options for device design.

The configuration and design of integrated speaker assemblies that maintain a broad frequency range and desirable acoustic performance levels can be challenging given the increasingly high demands for reduced size and high performance in a limited space. Therefore, a need exists for a speaker assembly that maintains functionality and performance while fitting within limited and unique housing volumes.

### SUMMARY

According to some aspects of the present disclosure, an electronic device can include a housing defining an opening, a speaker unit disposed within the housing and adjacent to the opening, the speaker unit including an asymmetric diaphragm, and an asymmetric magnet assembly.

In some examples, the electronic device can include a compensation feature to enable uniform movement of the asymmetric diaphragm. The compensation feature can include a surround attached to the asymmetric diaphragm, the surround having a variable stiffness. The asymmetric diaphragm can be non-symmetric across an axis bisecting a major surface of the asymmetric diaphragm. The asymmetric magnet assembly can include at least one of a plurality of asymmetrically aligned magnets, or an asymmetric magnet.

In some examples, the asymmetric magnet assembly can approximate a shape of the asymmetric diaphragm. The asymmetric diaphragm can be asymmetric along all axes of the diaphragm. The housing can define a volume, and the speaker unit and another separate electrical component can be disposed in the volume. A shape of the asymmetric diaphragm can accommodate at least one electrical component within the volume in the housing.

According to some aspects, a speaker unit can include a housing defining an internal volume, an asymmetric driver disposed in the housing, and a surround connected to the asymmetric driver, the surround having a first section having a first stiffness and a second section having a second stiffness different than the first stiffness.

In some examples, the first section can include a first material, and the second section can include a second, different material. The asymmetric driver can include a magnet assembly and a diaphragm, the magnet assembly having a center of mass that is off-axis from a center of mass of the diaphragm. The first stiffness and the second stiffness can be tuned to the asymmetric driver. The surround can include an ultraviolet cured silicone.

In some examples, the speaker unit can include a stiffening element positioned adjacent at least one of the surround or a diaphragm of the asymmetric driver. At least one of the surround or the diaphragm can be co-molded to the stiffening element. The asymmetric driver can include a magnet assembly and a diaphragm, a central axis of the magnet assembly can be non-coaxial with a central axis of the diaphragm.

According to some aspects, a speaker assembly can include a housing, a non-symmetric diaphragm disposed in the housing, and a non-symmetric magnet assembly approximating a shape of the non-symmetric diaphragm.

In some examples, the non-symmetric diaphragm can be a non-geometric shape. The non-symmetric magnet assembly can include a plurality of magnets having varying minimum distances between adjacent magnets of the plurality of magnets. The speaker assembly can include a silicone surround overmolded to the non-symmetric diaphragm, the silicone surround having a variable stiffness.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top view of an electronic device;

FIG. 1B shows a perspective view of an electronic device;

FIG. 1C shows a perspective view of an electronic device;

FIG. 1D shows a perspective view of an electronic device;

FIG. 2A shows a cross-sectional side view of components in an electronic device;

FIG. 2B shows a cross-sectional side view of components in an electronic device;

FIG. 3 shows a side view of a speaker assembly;

FIG. 4A shows a perspective exploded view of a speaker assembly;

FIG. 4B shows a cross-sectional perspective view of a speaker assembly;

FIG. 4C shows a top view of a magnetic component;

FIG. 4D shows a top view of components of a speaker assembly;

FIG. 5 shows a perspective view of a radiating member; and

FIG. 6 shows a perspective view of a radiating member.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to uniquely shaped speaker assemblies capable of operating within non-conventional spaces of electronic device housings. More specifically, the present disclosure relates to a speaker assembly (also referred to as a speaker unit) having a non-symmetric or asymmetric shape. As used herein, “asymmetric” or “non-symmetric” can refer to a lack of symmetry along one or more axes. For example, the asymmetry of a speaker assembly can refer to a cross-sectional shape of one or more components of the speaker assembly lacking symmetry along at least one axis, for example a major surface of a triangular diaphragm. In some examples, an asymmetric diaphragm can be non-symmetric across an axis that bisects a major surface of the asymmetric diaphragm.

Asymmetry can further relate to a position of one speaker component relative to another. For example, a magnet assembly or wound coil that is not centrally aligned or not positioned along a common vertical axis with the diaphragm (i.e. “not centered”) can be referred to as an asymmetric or non-symmetric speaker assembly. In some examples, an asymmetric alignment of the speaker components can exist when a center of mass of the magnet assembly is not vertically aligned (off-axis) with a center of mass of the diaphragm or radiating members. In some examples, asymmetry exists when a central axis of the magnet assembly is non-parallel with a normal vector of a major surface of the diaphragm. In some examples, asymmetry exists when a central axis of the magnet assembly is not aligned with a central axis of the diaphragm, that is, the diaphragm and the magnet assembly are non-coaxial.

In some examples, asymmetry can relate to a lack of symmetry along all axis of a components cross-section, also referred to as a “non-geometric shape.” Asymmetry can be determined based on perimeter shape or outline of a speaker component. In the context of the present disclosure, asymmetry can generally relate to any speaker assembly shape or configuration which could result in a non-uniform application of force on the diaphragm, causing non-uniform movement of one portion of a speaker diaphragm, frame, or surround relative to another portion, thus causing rocking in the speaker assembly.

Electronic devices are increasingly seeing a need for smaller form factors while maintaining or improving functionality. However, improving functionality can often necessitate more numerous, and often, large components. A specific example of this is in the field of head-mountable displays or “smart glasses”. Often, smart glasses house some or many of the various operational components within the support arms or frames of the smart glasses. However, the volume within the support arms can be limited and must remain so in order to not make the device too bulky or unaesthetic to the consumer.

Thus, a challenge of modern smart glasses is in fitting the desired operating components into the housing of the smart glasses. This disclosure specifically addresses the challenge of fitting the speaker assembly into the electronic device while maximizing performance. How loud a speaker is can be directly and linearly proportional to the size of the moving element, also referred to as a radiating member, radiating surface, and diaphragm. For example, a benefit of a larger diaphragm is a louder speaker that consumes less power. Therefore, a need exists to maximize the size or surface area of the diaphragm within the unique available space within the housing of the electronic device.

The speaker assembly or transducer can include two primary elements: the motor; and the moving element. The motor can include magnets and steel components forming frames and plates. The motor can convert electrical signals into mechanical forces. The moving element can include a coil and a surround that is driven by the motor. The motor and the moving element can be together referred to as a driver.

It is desirable to position and orient the speaker assembly in smart glasses or other head-mountable displays (HMD's) such that the speaker assembly is proximate to the user's ear and the sound is directed generally toward the user's ear to reduce the sound output (i.e., volume) required and also to enhance privacy. Depending on the shape of the support arm or a space within the support arms, these needs and desires may require that the speaker assembly to assume a unique shape, such as an asymmetric, non-symmetric, or non-geometric shape (i.e., having no symmetry along one or all of its axes).

In contrast, traditional speaker assemblies are symmetrical, often being circular and vertically aligned along a central axis. However, such a shape may not be suitable when trying to maximize the surface area of the speaker diaphragm within a uniquely shaped housing volume, for example a housing volume that is asymmetrical or otherwise irregularly shaped. Therefore, the present disclosure contemplates a speaker assembly to include a diaphragm shape that approximates the asymmetrical or otherwise irregular shape of the available space within the housing. In other words, by designing a diaphragm that is asymmetric to accommodate the available asymmetric space within the support arm, the surface area of the diaphragm can be maximized to take advantage of the available space and thereby improve performance.

However, several challenges arise when designing the diaphragm to be asymmetric. For example, non-uniform forces applied by the motor and non-uniform dynamic motions of the diaphragm can cause non-uniform movement and rocking (i.e., non-linear motion) within the speaker assembly. Non-uniform or non-linear motion of the speaker assembly can include a rotational motion of the diaphragm. Ideally, the diaphragms motion is uniform (i.e., oscillating linearly back and forth, without lateral or rotational movement. Further, when rocking is present, there is an increased chance of the moving elements hitting components of the speaker assembly. Rocking produces non-linear motion which decreases the performance of the speaker assembly (i.e., produces less sound).

The present disclosure overcomes these challenges by compensating for the non-uniform forces using a compensation feature. The compensation feature can include, at least, customized magnetic components, surrounds, and materials. In some examples, by selectively adjusting the stiffness of the surround, the assembly can compensate for the non-uniform motion of the diaphragm caused by its asymmetry. In other words, a variable or non-uniform stiffness of the surround can result in uniform movement of the diaphragm or associated components to reduce or eliminate rocking of the system. In some examples, this is achieved using a surround with a variable thickness. This can be done by modifying a shape of the surround mold for the overmolding process to create a surround with a customized or tuned stiffness.

Further, the challenges arising from an asymmetric design can be reduced or prevented by customizing the shape and configuration of the motor. The magnets of the motor can be intentionally sized and positioned in order to compensate for the asymmetry of the diaphragm such that the motor is generating a substantially uniform force on the diaphragm.

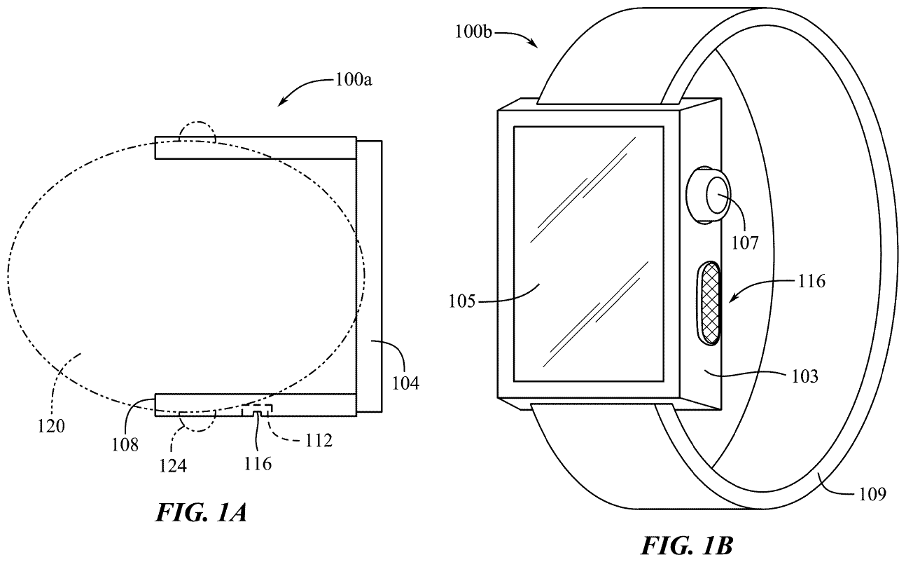

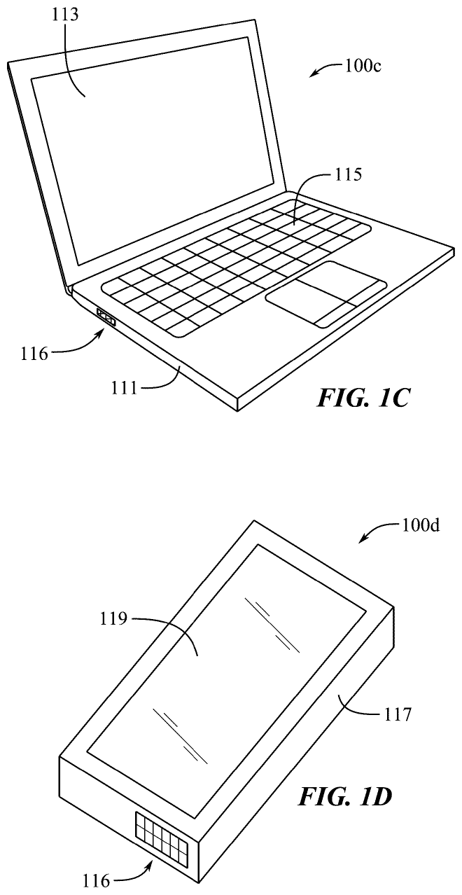

These and other embodiments are discussed below with reference to FIGS. 1-6. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1D illustrate various electronic devices that are capable of being used in conjunction with the speaker assembly described herein. The electronic devices can correspond to any form of a wearable electronic device, a portable media player, a media storage device, a portable digital assistant (“PDA”), a tablet computer, a computer, a mobile communication device, a GPS unit, a remote-control device, or any other electronic device. Specific examples of such devices are described below.

FIG. 1A illustrates an electronic device, such as a head-mountable device 100a positioned on a user's head 120. The head-mountable device 100a can include a display device 104 used for virtual or augmented reality simulations. The head-mountable device 100a can further relate to any form of computer glasses or smart glasses. The head-mountable device 100a can include a display 104 and a support 108, such as a headband or support arms. In some examples, the display 104 includes an opaque, translucent, transparent, or semi-transparent screen, including any number of lenses, for presenting visual data.

The head-mountable device 100a can be worn on the user's head 120 such that the display 104 is positioned at least partially over the user's face and disposed over one or both of the user's eyes. The display 104 can be connected to one or more supports 108. In some examples, the support 108 can be positioned against the side of a user's head 120 and in contact therewith. In some examples, the support 108 can be at least partially positioned above the user's ear or ears 124. The shape of the support 108 can be based on, or determined by, the position of the support 108 relative to the ear. In some examples, the support 108 can be positioned adjacent to the user's ear or ears 124. The support 108 can extend around the user's head 120. In this way, the display 104 and the support 108 can retain the head-mountable device 100a on the user's head 120. It should be understood, however, that this configuration is just one example of how the components of a modular head-mountable device 100a can be arranged, and that in some examples, a different number of components can be included.

The head-mountable device 100a can include a frame or housing that houses various electrical components. Various components of the display 104 can be housed within the housing. For example, the hardware and electronics which allow functionality of the head-mountable device 100a can be housed within the housing. The housing can be defined by any portion of the support 108 and/or the display 104.

In some examples, the head-mountable device 100a can include a speaker assembly 112. The speaker assembly 112 can be positioned in a housing of the head-mountable device 100a. For example, the speaker assembly 112 can be positioned in or on the support 108. The support 108 can define an opening 116 that is positioned proximate the speaker assembly 112 to permit passage of acoustic waves generated by the speaker assembly 112 to emit into the outside environment. In some examples, when the head-mountable device 100a is worn on the user's head 120, the speaker assembly 112 and the opening 116 are positioned proximate the user's ear 124. The support 108 and/or the opening 116 can be oriented such that sound can be directed toward the user's ear 124 when the user is wearing the head-mountable device 100a. The head-mountable device 100a is introduced as merely one example of an electronic device that can be integrated with the speaker assembly described herein. Further examples of electronic devices capable of incorporating the herein described speaker assembly are provided below with reference to FIGS. 1B-1D.

FIG. 1B illustrates an example in which the electronic device is a wearable device 100b. The wearable device 100b can be a watch, such as a smartwatch. The wearable device 100b of FIG. 1B is merely one representative example of a device that can be used in conjunction with the components and methods disclosed herein. In other words, the wearable device 100b is one non-limiting example of a device that can include a speaker assembly as described herein.

The wearable device 100b can include an enclosure or housing 103. The housing 103 can be connected to a front display 105 and can have a strap 109 designed to attach the wearable device 100b to a user, or to provide wearable functionality. The housing 103 can define a port 116 that is in fluid communication with a speaker assembly disposed within the housing 103. A number of input elements, such as a rotatable crown and/or a button 107 can be attached to and can protrude from the housing 103. The housing 103 can define a speaker port 116 that can be integrally formed in and defined by the housing 103. The housing 103 can house several electrical and mechanical components within a volume defined by the housing 103.

In some examples, the wearable device 100b can include a speaker assembly (not shown in FIG. 1B). The speaker assembly can be positioned in the housing 103 of the wearable device 100b. The housing 103 can define the port 116 that is positioned in relation to the speaker assembly to permit passage of acoustic waves generated by the speaker assembly to emit into the outside environment. In some examples, when the wearable device 100b is worn by a user, the port 116 is positioned or oriented to be directed toward the user's ear. The port 116 can be positioned such that sound can be directed toward the user's ear when the user is wearing the wearable device 100b.

FIG. 1C illustrates an example in which the electronic device is a computer 100c, such as a laptop or desktop computer. The computer 100c of FIG. 1C is merely one representative example of a device that can be used in conjunction with the components and methods disclosed herein. Specifically, the computer 100c is one representative example of a device that can include a speaker assembly as described herein.

The computer 100c can include an enclosure or housing 111. The housing 111 can be connected to a display 113. The housing 111 can define a port 116 that is in fluid communication with a speaker assembly housed within the housing 111. A number of input members 115, such as a keyboard, can be attached to and can protrude from the housing 111. The display 113 can include a touch sensitive surface, such as a touchscreen. The display 113 can define an exterior surface of the computer 100c.

The housing 111 can substantially define an internal volume and at least a portion of an exterior surface of the computer 100c. The housing 111 can also include features, such as such as button apertures or charging port apertures. In some examples, the housing 111 contains or houses several components including a speaker assembly as described herein. The speaker port 116 can be integrally formed in and defined by the housing 111.

In some examples, the computer 100c can include a speaker assembly (not shown in FIG. 1C). The speaker assembly can be positioned in the internal volume of housing 111 of the computer 100c. The housing 111 can define the port 116 that is positioned in relation to the speaker assembly to permit passage of acoustic waves generated by the speaker assembly to emit into the outside environment. The port 116 can be positioned such that sound can be directed toward the user's ear when the user is using the computer 100c

FIG. 1D illustrates an example in which the electronic device is a mobile device 100d, such as a smartphone or tablet computer. The mobile device 100d of FIG. 1D is merely one representative example of a device that can be used in conjunction with the components and methods disclosed herein. Specifically, the mobile device 100d is merely one representative example of a device that can include a single port speaker assembly as described herein.

The mobile device 100d can include an enclosure or housing 117. The housing 117 can be connected to a display 119. The housing 117 can define a port 116 that is in fluid communication with a speaker assembly disposed within the housing 117. In some examples, the housing 117 contains or houses several components including a speaker assembly as described herein.

The housing 117 can substantially define at least a portion of an exterior surface of the mobile device 100d. The display 119 can include a touch sensitive surface, such as a touchscreen. The display 119 can define an exterior surface of the mobile device 100d.

The housing 117 can also include features, such as such as button apertures or charging port apertures. In some examples, the housing 117 defines a speaker port 116 by the process described herein. The speaker port 116 can be integrally formed in the housing 117.

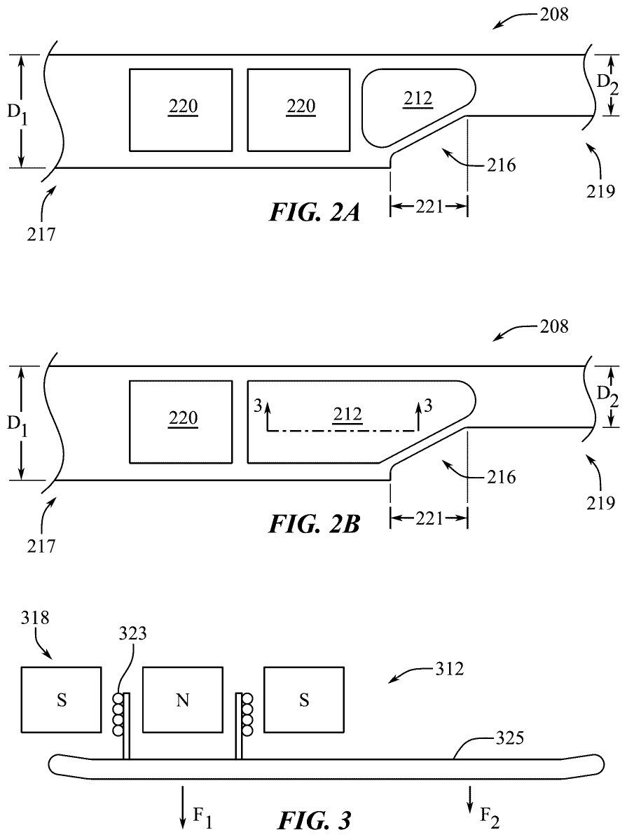

In some examples, the mobile device 100d can include a speaker assembly (not shown in FIG. 1D). The speaker assembly can be positioned in the housing 117 of the mobile device 100d. The housing 117 can contain or house several components in addition to the speaker assembly as described herein. The housing 117 can define the port 116 that is positioned in relation to the speaker assembly to permit passage of acoustic waves generated by the speaker assembly to emit into the outside environment. The port 116 can be positioned such that sound can be directed toward the user's ear when the user is using the mobile device 100d. Further details regarding speaker assemblies are described below with reference to FIG. 2A.

FIG. 2A illustrates a cross-sectional side view of a support 208 of an electronic device, such as the head-mountable device 100a. The support 208 can be substantially similar to, including some or all of the features of, the support 108, as discussed in FIG. 1A. The support 208 can be a headband or support arm used to support a head-mountable device to the user's face/head. In some examples, the support 208 can be positioned against the side of a user's head 120 and in contact therewith. In the example illustrated in FIG. 2A, the support 208 can be at least partially positioned above the user's ear or ears 124. The shape of the support 208 can accordingly be based on the anatomy of a user's head and ear.

In some examples, a first end 217 of the support 208 can be connected or attached to a display or frame of the head-mountable device, and a second end 219 of the support 208 can be positioned opposite the first end 217, behind or rearward of a user's ear, such that the user's ear is positioned between the first end 217 and the second end 218 of the support 208. In some examples, the support 208 can have a varying width (measured from a top of the support 208 to a bottom of the support 208). For example, the first end 217 can have a width of D₁ and the second end 219 can have a width D₂. In some examples D₁ is greater than D₂. In other words, the support 208 can taper or narrow when approaching the second end 219. The tapering of the support 208 can occur at a transition section 221 between the first end 217 and the second end 219.

In some examples, the transition section 221 can be angled, slanted, curved, or otherwise shaped in order to accommodate a user's ear. The geometry of the transition section 221 can aid in securing the support 208 to the user's head and can improve comfort of the support 208 on the user's head. In some examples, the transition section 221 can be positioned above and slightly forward (i.e., toward the user's face) of the user's ear. Thus, a normal vector of a lower surface or profile of the transition section 221 can point approximately in the direction of the user's ear, while the support 208 is worn by the user. In some examples, a port or opening 216 can be defined by a housing of the support 208, positioned at or near the transition section 221. The opening 216 can be in fluid communication with an internal volume defined by the housing of the support 208.

The internal volume can house one or more electrical or mechanical components 220. The components 220 can include one or more of a battery, a central processing unit (CPU), a multi-layer board (MLB), a haptic component, an audio component, and any number of applicable sensors and circuitry. The support 208 can additionally house a speaker assembly 212.

As described herein, the support 208 can include a small form factor. Thus, a challenge arises from the need to fit the several components 220, as well as the speaker assembly 212, into the limited space of the internal volume of the support 208. This constraint can result in limited, non-symmetric volumes into which the components 220 and speaker assembly 212 can fit. Accordingly, the present disclosure contemplates a speaker assembly 212 have a non-traditional shape. In some examples, the speaker assembly 212 can be asymmetric or non-symmetric (through one or all of its axes). In some examples, the speaker assembly 212 can be a non-geometric shape (i.e., having no symmetry). As illustrated in FIG. 2A, the speaker assembly 212 can be generally triangular in shape. In some examples, the speaker assembly 212 can include rounded or smooth corners, preventing potential complications from sharp corners or edges. For example, rounded corners in the speaker assembly 212 can limit stress concentrations and result in low stresses and forces. Rounded corners can also result in more physical clearance for various internal moving elements of the speaker assembly 212, such as a diaphragm, wound coil, and surround.

By shaping the speaker assembly 212 in the manner described herein, performance of the speaker assembly can be maximized for the available space in which it is housed. The speaker assembly 212 can be positioned within the internal volume of the support 208. In some examples, an entirety of the speaker assembly 212 is positioned within the internal volume. The opening 216 can be in fluid communication with the ambient environment and the speaker assembly 212. In some examples, an angle of a side of the speaker assembly 212 is substantially similar to an angle of the transition section 221. In other words, the shape of the speaker assembly 212 can be at least partially based on the shape of the transition section 221.

Any of the features, components, and/or parts, including the arrangements and configurations thereof shown in FIG. 2A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2A.

FIG. 2B shows a cross-sectional side view of the support 208 of an electronic device, such as the head-mountable device 100a. The support 208 of FIG. 2B can be substantially similar to, or include some or all of the features of, the support 208 of FIG. 2A. In some examples, the speaker assembly 212 can be generally trapezoidal in shape. Other shapes are also possible and contemplated using the methods and systems described herein. It will be understood that the shape and/or the position of the speaker assembly 212 can be determined based on the shape, size, and placement of the support 208, as well as the components 220 within the support 208.

Any of the features, components, and/or parts, including the arrangements and configurations thereof shown in FIG. 2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2B.

FIG. 3 shows a side view of select components of a speaker assembly 312. The speaker assembly 312 is an example representation of a side cross-sectional view of the speaker assembly 212 of FIGS. 2A and 2B. It will be understood that certain components and features have been omitted for clarity. As described above, asymmetry as used herein can apply to a misalignment of the vertical axis of one or more components in the speaker assembly. That is, even if the major surface of the diaphragm is symmetric, the positioned on the coil and/or magnet assembly can result in an asymmetric speaker assembly. One consequence of an asymmetric speaker assembly is that it can result in unequal forces distributed by the speaker motor. FIG. 3 illustrates the unequal forces that can arises from an asymmetric design. The speaker assembly 312 can be substantially similar to, including some or all of the features of, the speaker assembly 208. The speaker assembly 312 can include a diaphragm 325 (also referred to as a radiating member or moving member) that is configured to move, vibrate, or oscillate up and down in order to generate acoustic waves. The diaphragm 325 can be asymmetric. The diaphragm 325 can be physically connected with a coil 323, such as a wound coil. The coil 323 can be positioned to magnetically interact with a magnetic component 318 (also referred to as a magnet assembly).

The magnetic component 318 can include a gap or groove within which the coil 323 can be disposed, such as a copper coil or any conductive coil that can carry electrical current to create an electromagnetic field. In some examples, the coil 323 can be any component capable of generating an electric field or being influenced by an electromagnetic field. The diaphragm 325 can be affixed to the coil 323. As pulses of electricity pass through the coil 323, the direction of its magnetic field can be rapidly changed, resulting in alternating attraction and repulsion forces to the magnetic component 318, causing vibrations back and forth (i.e., up and down movements as oriented in FIG. 3). The coil 323 can be secured to the diaphragm 325 such that oscillations of the coil can be transferred to the diaphragm 325, which can amplify these vibrations, pumping sound waves into the surrounding air.

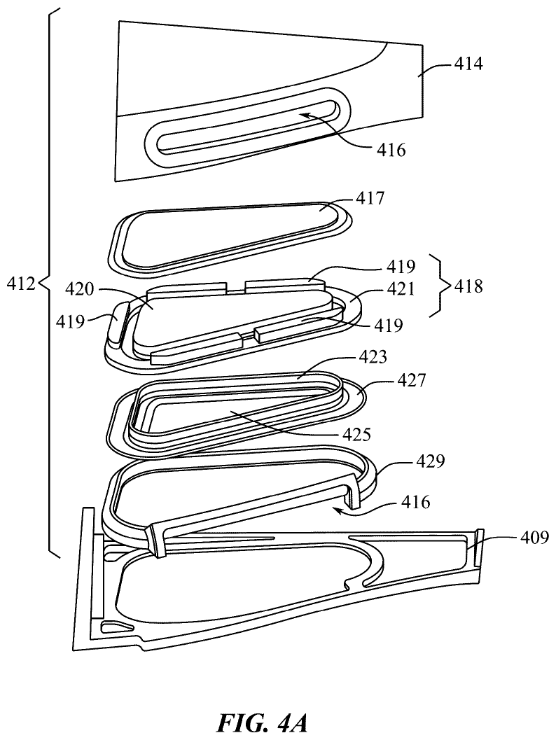

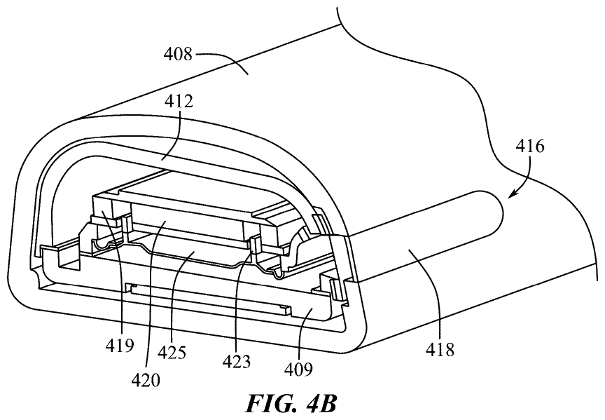

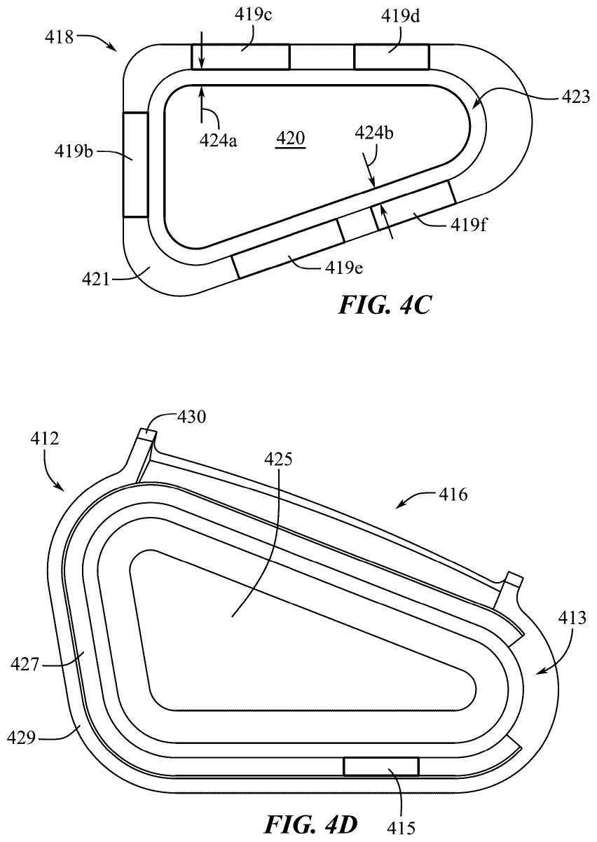

As illustrated, because the diaphragm 325 is asymmetric, the coils 323 and magnetic component 318 may be positioned off-center or off-axis relative to a central axis of the diaphragm 325, which can result in an uneven force distribution onto the diaphragm 325 as the movements from the coil 323 are transferred to the diaphragm 325. FIG. 3 illustrates an example in which the magnetic component 318 and coil 323 are located primarily on the left side of the diaphragm 325. As a result, when the magnetic component 318 drives the coil 323, the diaphragm 325 experiences a first force F1 on the left side of the diaphragm 325, and a second, smaller force F2 on the right side of the diaphragm. This imbalance in forces acting on the diaphragm 325, in addition to the shape of the diaphragm 325 itself, can cause a larger displacement/movement of the diaphragm 325 near the first force F1 and less displacement/movement near the second force F2. In turn, the asymmetry of the speaker assembly 312 can lead to undesirable effects such as rocking and rotation of the diaphragm 325. However, components such as the magnetic component 318, diaphragm 325, speaker assembly frames and surrounds (shown in subsequent figures) are configured to compensate or counteract the imbalance of forces F1, F2 due to the asymmetry of the speaker assembly 312 and cause uniform movement of the diaphragm and other moving components of the speaker assembly. FIG. 4A-6 discuss methods and systems for preventing or compensating for non-uniform forces on an asymmetric diaphragm.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4A shows a perspective exploded view of a speaker assembly 412. FIG. 4B shows a cross-sectional perspective view of the speaker assembly 412. The speaker assembly 412 can be substantially similar to, including some or all of the features of, the speaker assemblies described herein, including speaker assemblies 112, 212, and 312. The speaker assembly 412 can include a housing 414 that defines an internal volume to house various speaker components. The speaker assembly 412 can include a yoke 417 positioned above a magnetic component 418. In some examples, the yoke 417 can be connected to the magnetic component 418. In some examples, the yoke 417 can partially define a back volume and can provide stability for the magnetic component 418. The yoke 417 can be made from stainless steel.

The magnetic component 418 can be positioned below the yoke 417. In some examples, the magnetic component 418 includes one or more magnets 419, 420. In the specific example illustrated in FIG. 4A, the magnetic component includes 6 individual magnets 419 and 420. The magnets can be individual, distinct, or separate from one another. The magnets 419, 420 can be in contact with one another or can be physically separated from one another, such that a gap or separation exists between one or more of the magnets 419, 420. In some examples, the magnets 419 can have varying shapes and sizes. The present disclosure contemplates modifying the electromagnetic field generated by the magnets 419, 420 by customizing the position, size, and shape of the magnets 419, 420.

In the specific example illustrated in FIG. 4A, the magnetic component 418 can include a primary central magnet 420 that is at least partially surrounded by smaller magnets 419. In some examples, the magnetic component 418 includes a plate 421. The plate 421 can support the magnets 419. In some examples, the magnets 419, 420 are connected to the plate 421. In some examples, the plate 421 can include several sections. The sections of the plate 421 can be separated from one another (e.g., non-unitary and not in direct physical contact). For example, the plate 421 can include a gap between a central portion and a perimeter portion (this is described in greater detail below with regard to FIG. 4D). The plate 421 can include stainless steel. Additional detail of the magnetic component 418 is provided below, with reference to FIG. 4D.

A coil 423 can be positioned and shaped to be received by the plate 421, between the smaller magnets 419 and the primary central magnet 420. Accordingly, the shape of the coil 423 can approximate the shape of the magnetic component 418. As such, the shape of the coil 423 can approximate an asymmetric triangle, as shown in FIG. 4, or any other irregular or non-circular shape as noted herein. As described herein, the shape of the coil 423 can be based on or determined by the shape of the diaphragm 425, which in turn is determined by the available volume within a housing of the electronic device. The coil 423 can be attached to the diaphragm 425 and/or a surround 427.

The shape of the diaphragm 425 can be based on or determined by the shape of the available volume within a housing of an electronic device. The shape of the surround 427 can be based on a perimeter of the diaphragm 425. The surround 427 can be a flexible material that allows the diaphragm 425 to move in response to forces from the magnet assembly 418 that is coupled to the diaphragm 425 and to a frame 429. Thus, the surround 427 can join or couple the diaphragm 425 to the frame 429. The surround 427 can act as a spring to form a suspension of the diaphragm 425 within the frame 429. The surround 427 can be a thin silicon membrane that goes around perimeter of the diaphragm 425 and may provide a seal against the frame 429.

The speaker assembly 412 can include the frame 429 that can support components of the speaker assembly 412. In some examples, the frame 429 supports the diaphragm 425 and/or the surround 427. In some examples, the surround 427 is attached to the frame 429. The frame 429 can at least partially define a port 416. As illustrated in FIG. 4B, the port 416 can include a screen or mesh 418. The screen 418 can prevent particle ingress into the housing 409.

In some examples, the port 416 is partially surrounded by a foam or sealing member configured to seal the frame against the housing 414. In some examples, the yoke 417 can be attached or sealed to the frame 429.

The speaker assembly 412 can include an enclosure bottom 409. In some examples, the enclosure bottom 409 at least partially defines an internal volume that houses the speaker assembly 412. In some examples, the enclosure bottom 409 and the enclosure top 414 together define an internal volume that houses the components of the speaker assembly 412. In some examples, the enclosure top 414 and the enclosure bottom 409 define the external and/or internal surfaces of an electronic device, such as a head-mountable device 100a or a support 208. In some examples, the frame 429 can be attached to or sealed to the enclosure bottom 409.

In some examples, the speaker assembly 412 can include various acoustic components, such as audio transducers, woofers, tweeters, midrange drivers and any other types of drivers or speaker components. Further details of speaker assemblies are described below with reference to FIG. 4C-4D. As used herein, the term “driver” can refer to a motor, including a magnetic component of a motor, and a moving element, including a diaphragm, of a speaker assembly.

FIG. 4C shows a top view of the magnetic component 418. It will be understood that FIG. 4C illustrates one example configuration of a magnetic component, and that several other designs and configuration are contemplated and can be tailored or customized to the shape of the diaphragm. In some examples, the configuration of the magnetic component 418, including the number, placement, and strength of the magnets is predetermined in order to compensate for an asymmetric diaphragm. In some examples, the magnetic component 418 can include a plurality of asymmetrically aligned magnets. For example, the individual magnets of the magnetic component 418 can be asymmetrically aligned relative to each other. In some examples, the various magnets of the magnetic component 418 can be arranged to form a shape that is asymmetrical about one or more axes. This shape can approximate a shape of one or more other components of the speaker assembly 412, including a shape of the diaphragm 425, frame 429, surround 427, and so forth. In some examples, the magnetic component 418 can be asymmetrically aligned relative to the diaphragm. For example, the magnetic component 418 can be off-axis from a central axis or center of mass of the diaphragm, resulting in an asymmetrically aligned speaker assembly. One example of such an asymmetry is shown in FIG. 3 and described above.

In some examples, the magnetic component 418 can include a central magnet 420 and several perimeter magnets 419b, 419c, 419d, 419e, and 419f (collectively referred to as 419b-419f). The central magnet 420 can be a primary magnet that is surrounded by, and larger than, the perimeter magnets 419b-419f. In some examples, the central magnet 420 can include multiple magnets. In some examples, the central magnet 420 has a shape, such as a cross-sectional shape, that approximates a shape of the diaphragm and/or speaker housing.

The perimeter magnets 419b-419f can be individual, distinct, or separate from one another and from the central magnet 420. The perimeter magnets 419b-419f can be in contact with one another or can be physically separated from one another. In some examples, the placement of the perimeter magnets 419b-419f can at least partially surround a perimeter of the central magnet 420.

In some examples, the magnetic component 418 includes a plate 421. The plate 421 can support at least the perimeter magnets 419b-419f. The perimeter magnets 419b-419f can be connected to the plate 421 using a variety of attachment methods, including adhesives. In some examples, the plate 421 can have an asymmetric shape that approximates the shape of the central magnet 420 and/or a diaphragm of the speaker. The plate 421 can define a gap 424 between the central magnet 420 and perimeter magnets 419b-419f. The gap 424 can be configured to receive a coil connected to a diaphragm. In some examples, the gap 424 varies in width (i.e., the distance between the plate 421 and the central magnet 420 and/or a central plate portion). A minimum distance between the central magnet 420 and plurality of magnets 419b-419f can be non-constant or varying.

For example, a distance 424a between the perimeter magnet 419c and the central magnet 420 can be different than a distance 424b between the perimeter magnet 419f and the central magnet 420. In some examples, the distance 424a can be less than the distance 424b in order to provide a stronger magnetic force acting on the coil at that location. Likewise, the distance 424b can be greater than the distance 424a in order to lessen the magnetic force acting on the coil at that location. The greater and/or lesser forces achieved by a varying gap 424 can be used to reduce or eliminate non-uniform (i.e., non-linear) motion of the diaphragm, caused by an asymmetric diaphragm and/or caused by an off-axis alignment of the magnetic component 418 relative to the diaphragm.

In some examples, there are a greater number of magnets positioned proximate a larger mass of the diaphragm and fewer magnets positioned proximate a smaller portion of the diaphragm. For example, as shown in FIG. 4C, the asymmetrical shape of the diaphragm may approximate the asymmetrical triangular shape of the magnetic component 418 such that a larger mass of the diaphragm results in a center of mass of the diaphragm positioned closer to the perimeter magnet 419c than the perimeter magnet 419f. In such an example, the gap 424a between the perimeter magnet 419c and the central magnet 420 can be less than the gap 424b between the perimeter magnet 419f and the central magnet 420. As a result, a larger force generated between the perimeter magnet 419c and the central magnet 420 (relative to the smaller force generated between the perimeter magnet 419f and the central magnet 420) would act on the larger mass of the diaphragm to equalize a displacement of the diaphragm at those two points of the diaphragm (the two points corresponding to the two perimeter magnets 419a and 419f).

This is one non-limiting example of how varying gaps 424 between magnets 419a-f, 420 of the magnetic component 418 can compensate for asymmetrical speaker assemblies 412 and components thereof. However, one will appreciate that any number of force and displacement imbalances, which depend on specific shapes and relative positions of various components of the speaker assembly 412, can be compensated for or corrected by customized gap sizes between one or more other magnets 419a-f, 420 of the magnetic component 418.

In some examples, the distance between the perimeter magnets 419b-419f and the coil can vary. This change in the gap 424 can be designed to adjust the forces that the coil experiences by the magnetic component 418. The plate 421 can include separated sections (e.g., non-unitary and not in direct physical contact). For example, the plate 421 can a central portion (e.g., attached to the central magnet 420 and a perimeter portion (e.g., attached to the perimeter magnets 419b-419f). The plate 421 can include metal, such as stainless steel, plastic, or other suitable materials.

In this way, customized magnetic components, including positions of magnets and gaps therebetween, can compensate for the asymmetry of the diaphragm or speaker assembly by providing substantially uniform forces and thus uniform movements. In addition, the surround 427 can work individually or in concert with the magnetic component 418 to prevent rocking.

FIG. 4D shows a top view of various components of the speaker assembly 412. As shown, the diaphragm 425 can be connected to, and at least partially surrounded by, the surround 427. The frame 429 can be connected (e.g., via adhesives) to the surround 427 and/or the diaphragm 425. In some examples, the frame 429 can aid or assist in enabling uniform motion of the diaphragm 425. For example, a portion 413 of the frame 429 can extend or overlap certain sections of the surround 427 in order to provide stiffness or rigidity to that region to prevent rocking of the diaphragm 425. The portion 413 can be referred to as a stiffening element. The stiffening element 413, can modulate the stiffness of the surround 427 based on the asymmetric shape of the diaphragm 425. The stiffening element 413, can be integrally formed with the frame 429, such as portion 413, or can be a separate component, such as stiffening element 415, connected or otherwise integrated with the surround 427. In one example, the stiffening element 415 can add to or alter a shape or cross-sectional shape of the surround 427 to provide added stiffness. In one example, the stiffening member 415 can include a stiffer material than the surround 427 to add stiffness.

In one example, the stiffening element 415 can be attached to or be placed in contact with an exterior of the surround 427. In some examples, the stiffening element 415 can be an insert that is positioned within an interior of the surround 427. The stiffening element 413, 415 can be positioned in predetermined locations along the sections of the diaphragm 425 that experience greater forces, resulting in rocking or non-uniform motion. In some examples, at least one of the surround and the diaphragm can be co-molded to the stiffening element 413, 415 and/or the frame 429. In some examples, the frame at least partially defines the opening 416 through which sound can be propagated. A seal or foam 430 can be connected to the frame 429 and can provide a seal between the frame 429 and the support 408.

Any of the features, components, and/or parts, including the arrangements and configurations thereof shown in FIGS. 4A-4D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4D.

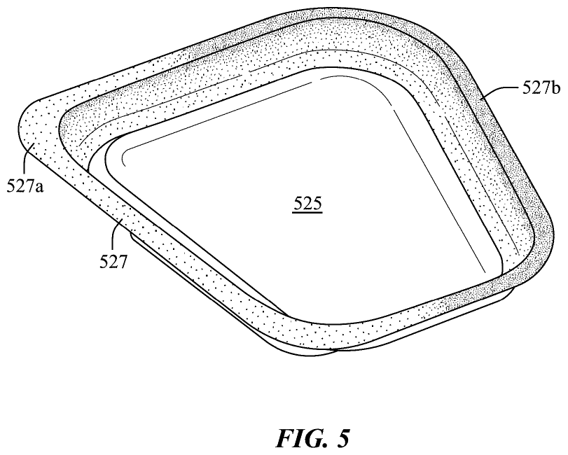

FIG. 5 shows a perspective view of a diaphragm 525 and a surround 527. The diaphragm 525 and surround 527 can be substantially similar to, including some or all of the features of, the diaphragms and surrounds described herein, such as the diaphragm 425 and the surround 427, respectively. In some examples, a stiffness or rigidity of the surround 527 can vary in order to compensate for the asymmetric design of a diaphragm. By altering the stiffness of the surround 527, non-uniform motion and rocking of the diaphragm can be reduced or prevented. For example, the asymmetric diaphragm 525 may experience a lesser force near the first section 527a, and a stronger force nearer the second section 527b.

For example, a magnetic component may be positioned closer to the second section 527b, resulting in the second section 527b experiencing a stronger force than the first section 527a. Accordingly, the second section 527b can be stiffer than the first section 527a in order to compensate for the uneven forces acting on the diaphragm 525. The higher stiffness can result in a smaller displacement of the diaphragm 525 when acted on by the force transferring through the surround 527 to the diaphragm 525. In some examples, due to the shape of the diaphragm 525, a size and shape of the first section 527a can be different than a size and/or shape of the second section 527b and in order to compensate for the differences, the first section 527a can be more or less stiff than the second section 527b.

Accordingly, in order to compensate for the non-uniform forces and reduce non-linear motion, the second section 527b may be stiffer or thicker than the first section 527a. In some examples, it may be desirable for the surround 527 to be stiffer along one or more curves or corners of the diaphragm 525. In some examples, it may be desirable for the surround 527 to be stiffer along one or more linear edges or sides the diaphragm 525. In some examples, it may be desirable for the surround 527 to be stiffer along a short side of the diaphragm 525, while the surround 527 that is adjacent a long side of the diaphragm 525 is less stiff. In some examples, it may be desirable for the surround 527 to be stiffer along a long side of the diaphragm 525, while the surround 527 that is adjacent a short side of the diaphragm 525 is less stiff. FIG. 5 represents the varying stiffness of the surround using a dot density pattern, with the variations in the dot density representing variations in the stiffness, thickness, or rigidity of the surround 527. For example, the denser sections can represent stiffer regions of the surround 527, or alternatively, the denser sections can represent less stiff regions. It will be understood that the configuration of variations of stiffness around the surround 527 is not limited to the illustrated embodiment.

For example, the surround 527 can include a first section 527a and a second section 527b. Despite being a unitary component the first section 527a and the second section 527b can be distinguish based on different levels of stiffness between the two sections. In some examples, the stiffness of the surround 527 is based on a length of a side of the diaphragm 525 relative to its other sides. The varying stiffness of the surround 527 can be a result of several factors. For example, the addition of a stiffening element, such as described above with reference to FIG. 4D, can cause a change in stiffness between the first section 527a and the second section 527b. In some examples, the geometry (i.e., shape, length, thickness) of the surround 527 can change, resulting in a change in stiffness between the first section 527a and the second section 527b. In some examples, the density of the first section 527a may be different than the density of the second section 527b, resulting in a varying stiffness of the surround 527. In some examples, the manufacturing process of the surround 527 can cause the varying stiffness. For example, the first section 527a and second section 527b may be exposed to different temperatures or curing processes when being formed to achieve the desired differences in stiffness.

In some examples, the surround 527 can be overmolded. The surround 527 can include an ultra-violet (UV) curable silicone. In some examples, the tooling using in the formation process can be at least partially transparent to allow UV light to pass through the tool and cure the silicone during tooling. In some examples, the UV curable silicone has inherent dampening properties. In some examples, the surround 527 can include polymers and/or elastomers, such as thermoplastic elastomer (TPE), thermoplastic rubber, thermoplastic polyurethane (TPU), or any other soft polymer or elastomer.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

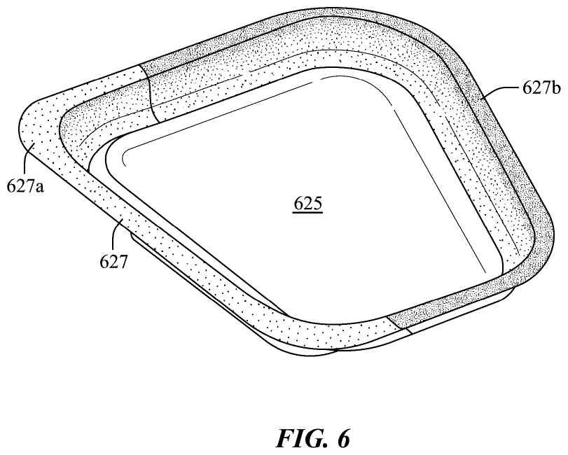

FIG. 6 shows a perspective view of a diaphragm 625 and a surround 627. The diaphragm 625 and surround 627 can be substantially similar to, including some or all of the features of, the diaphragms and surrounds described herein, such as the diaphragms 425, 527 and the surrounds 427, 527, respectively. In some examples, the surround 627 can include multiple sections and/or materials in order to compensate for the asymmetric design of the diaphragm. By selectively providing certain materials at select locations along the surround 627, non-uniform motion and rocking of the diaphragm 625 can be reduced or prevented. For example, a stiffer, thicker, or more rigid material can be provided at a location that experience a higher degree of forces.

FIG. 6 illustrates multiple materials that form the surround 627, with the respective stiffness of the materials represented using a dot density pattern. The density in the dots can represent the stiffness, thickness, or rigidity of the surround 627. For example, the denser sections can represent stiffer regions of the surround 627, or alternatively, the denser sections can represent less stiff regions. It will be understood that the configuration of variations of stiffness around the surround 627 is not limited to the illustrated embodiment. The materials that form the surround 627 can have variations in the stiffness, thickness, or rigidity of the materials. For example, the surround 627 can include a first material forming a first section 627a and a second material forming a section 627b. The side, shape, and position of the first section 627a and the second section 627b, as illustrated in FIG. 6, is merely one example configuration. It will be understood that the size, shape, and positions of the first section 627a and the second section 627b are not limited to the embodiment illustrated in FIG. 6.

In some examples, the first material of the first section 627a and the second material of the second section 627b are non-unitary. In some examples, the stiffness and/or thickness of the first material is different than the stiffness and/or thickness of the second material. In some examples, the existence and placement of different materials that form the surround is based on the shape of the diaphragm and/or the location of the motor, including the magnetic component and coil, relative to the diaphragm 625.

For example, a magnetic component may be positioned closer to the second section 627b, resulting in the second section 627b experiencing a stronger force than the first section 627a. Accordingly, the second section 627b can be stiffer than the first section 627a in order to compensate for the uneven forces acting on the diaphragm 625. In some examples, due to the shape of the diaphragm 625, a size and shape of the first section 627a can be different than a size and/or shape of the second section 627b and in order to compensate for the differences, the first section 627a can be more or less stiff than the second section 627b. Accordingly, in order to compensate for the non-uniform forces and reduce non-linear motion of the diaphragm 625, the second section 627b may be stiffer or thicker than the first section 627a.

In some examples, it may be desirable for the surround 627 to be stiffer along one or more curves or corners of the diaphragm 625. In some examples, it may be desirable for the surround 627 to position stiffer material, along one or more linear edges or sides the diaphragm 625. In some examples, it may be desirable for the surround 627 to include a stiffer material along a short side of the diaphragm 625, while the material that is adjacent a long side of the diaphragm 625 is less stiff. In some examples, it may be desirable for the surround 627 to include a stiffer material along a long side of the diaphragm 625, while the material that is adjacent a short side of the diaphragm 625 is less stiff.

In other words, the moving mass, including the surround 627 and the diaphragm 625 can include a multi-material assembly having different silicone grades positioned in different areas and intended to compensate for rocking of the moving mass and produce uniform movement at all locations of the diaphragm 625 during use.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

Personal information data, gathered pursuant to authorized and well established secure privacy policies and practices that are appropriate for the type of data collected, can be used to implement and improve on the various embodiments described herein. The disclosed technology is not, however, rendered inoperable in the absence of such personal information data.

It will be understood that the details of the present systems and methods above can be combined in various combinations and with alternative components. The scope of the present systems and methods will be further understood by the following claims.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device, comprising:
a housing defining an opening;
a speaker unit disposed within the housing and adjacent to the opening, the speaker unit comprising:
an asymmetric diaphragm; and
an asymmetric magnet assembly.

2. The electronic device of claim 1, further comprising a compensation feature to enable uniform movement of the asymmetric diaphragm, the compensation feature comprising a surround attached to the asymmetric diaphragm and the surround comprising a variable stiffness.

3. The electronic device of claim 2, wherein the asymmetric diaphragm is non-symmetric across an axis bisecting a major surface of the asymmetric diaphragm.

4. The electronic device of claim 1, wherein the asymmetric magnet assembly comprises at least one of a plurality of asymmetrically aligned magnets or an asymmetric magnet.

5. The electronic device of claim 1, wherein the asymmetric magnet assembly approximates a shape of the asymmetric diaphragm.

6. The electronic device of claim 1, wherein the asymmetric diaphragm is asymmetric along all axes of the diaphragm.

7. The electronic device of claim 1, wherein:
the housing defines a volume; and
the speaker unit and another separate electrical component are disposed in the volume.

8. The electronic device of claim 7, wherein a shape of the asymmetric diaphragm accommodates at least one electrical component within the volume in the housing.

9. A speaker unit, comprising:
a housing defining an internal volume;
an asymmetric driver disposed in the housing; and
a surround connected to the asymmetric driver, the surround comprising a first section having a first stiffness and a second section having a second stiffness different than the first stiffness.

10. The speaker unit of claim 9, wherein the first section comprises a first material, and the second section comprises a second, different material.

11. The speaker unit of claim 10, wherein the asymmetric driver comprises a magnet assembly and a diaphragm, the magnet assembly having a center of mass that is off-axis from a center of mass of the diaphragm.

12. The speaker unit of claim 9, wherein the first stiffness and the second stiffness are tuned to the asymmetric driver.

13. The speaker unit of claim 9, wherein the surround comprises an ultraviolet cured silicone.

14. The speaker unit of claim 9, further comprising a stiffening element positioned adjacent at least one of the surround or a diaphragm of the asymmetric driver.

15. The speaker unit of claim 14, wherein at least one of the surround or the diaphragm is co-molded to the stiffening element.

16. The speaker unit of claim 9, wherein the asymmetric driver comprises a magnet assembly and a diaphragm, a central axis of the magnet assembly being non-coaxial with a central axis of the diaphragm.

17. A speaker assembly, comprising:
a housing;
a non-symmetric diaphragm disposed in the housing; and
a non-symmetric magnet assembly approximating a shape of the non-symmetric diaphragm.

18. The speaker assembly of claim 17, wherein the non-symmetric diaphragm is a non-geometric shape.

19. The speaker assembly of claim 17, wherein the non-symmetric magnet assembly comprises a plurality of magnets having varying minimum distances between adjacent magnets of the plurality of magnets.

20. The speaker assembly of claim 17, further comprising a silicone surround overmolded to the non-symmetric diaphragm, the silicone surround having a variable stiffness.
